(19) United States
(12) Patent Application Publication
(10) Pub. No.: US 2015/0199102 A1
(43) Pub. Date: Jul. 16, 2015

(54) DEVICE DRIVING SYSTEM THROUGH TOUCH INPUT IN LOW POWER MODE IN WHICH DISPLAY IS OFF

(71) Applicant: SEMISENS CO., LTD., Gyeonggi-do (KR)

(72) Inventors: Jin Seok KOH, Gyeonggi-do (KR); Wan Joong KIM, Gyeonggi-do (KR); Hyeon Su KIM, Gyeonggi-do (KR)

(21) Appl. No.: 14/335,926

(22) Filed: Jul. 20, 2014

(30) Foreign Application Priority Data
Jan. 14, 2014 (KR) 10-2014-0004312

(51) Int. Cl. G06F 3/0488; G06F 3/0481; G06F 3/041

(52) U.S. Cl. CPC G06F 3/0488; G06F 3/041; G06F 3/04817; G06F 2203/04106

(57) ABSTRACT

The present invention relates, in general, to a system and a method for quickly driving a device through a touch input in a low power mode in which a display of the device is off. More particularly, the present invention relates to a device driving system and a device driving method, which can minimize power consumption through only a predetermined touch input in a low power mode in which a display of a device is off, and quickly perform unlocking of the device, system control or execution of an application.

### CROSS-REFERENCE TO RELATED APPLICATION AND CLAIM OF PRIORITY

This application claims the benefit of Korean Patent Application No. 10-2014-0004312, filed on Jan. 14, 2014, in the Korean Intellectual Property Office, the disclosures of which are incorporated herein in their entirety by reference.

### BACKGROUND

1. Technical Field

The present invention relates, in general, to a system and a method for quickly driving a device through a touch input in a low power mode in which a display of the device is off More particularly, the present invention relates to a device driving system and a device driving method, which can quickly perform unlocking of a device, system control or execution of an application while minimizing power consumption through only a predetermined touch input in a low power mode in which a display of the device is off; minimize power consumption in the low power mode by executing a low power algorithm for minimizing an algorithm for analysis of a user's touch input, limiting and setting an effective touch area of a touch panel to a partial area of the touch panel, minimizing the number of scans required of the effective touch area of the touch panel, or changing a touch input method between a general mode and the low power mode; allow the user to set a user's own touch input for executing a specific application in the low power mode; and increase a recognition rate with respect to a predetermined touch input by storing information on a touch input pattern input by the user and databasing the pattern type of a specific touch input through storing of the information.

2. Background Art

As touch screens are employed in devices including smart phones, tablet computers, notebook computers, cameras and the like, users conveniently use touch screen input methods more intuitively and conveniently than conventional input methods and thus easily learn to use such devices. Touch screen systems initially supported relatively simple motions including pointing, gesture recognition and the like, but the technology of touch screens is rapidly evolving.

Touch screen devices are mostly developed for mobile devices and greatly affect to power consumption. Therefore, most touch screen devices actively manage power consumption, via processes such as a power saving mode, a standby mode and a use mode, in order to minimize power consumption. If a device enters into a low power mode (here, the low power mode is a concept including a standby mode or power saving mode in which a display of the device is off in order to minimize power consumption, and hereinafter will be identically used in the entire specification), the device manages power consumption device on a system in order to minimize the power consumption. The device cuts off power to the display and does not receive any touch screen input. That is, the device should exit from the low power mode to recognize a touch input. However, a separate user input such as pushing a physical button is currently required to wake the device from the low power mode.

That is, in a conventional method, a user first activates the display and the touch screen by pressing a power button of the device in order to execute a specific application with an intention in the low power mode in which the power of the display of the device is off. Subsequently, when the display is turned on and the touch screen is activated, a locking screen may appear. If the user inputs an unlocking pattern, a personal identification number, or the like on the locking screen, a home screen appears, and the user searches for an icon on the home screen or an icon of the desired application by touching a menu button. Subsequently, when the icon of the desired application is located, the user touches the icon, thereby executing the desired application.

The conventional method has the following problems.

First, when the device is in the low power state (low power mode), the low power mode is necessarily converted into the use mode through use of a physical button. When a user has intent to use the device, the user has already prepared for an input to the touch screen. In this case, there is an inconvenience that the user should take an additional separate action to press a physical button (or soft button).

Second, when the device is in a low power state, the user should go through many processes to execute an application with an intention. This means that the time taken from when the user intends to use the application to when the user actually executes the application becomes long. For example, although a user of a smart phone wants to photograph a beautiful scene through a camera application, processes performed to drive the camera application are very inconvenient, and much time is taken to execute the camera application. Therefore, the user may miss the opportunity to photograph the desired scene.

Third, there is an inconvenience that in order to perform control of a low power background application or a system control, the user should perform the control through a button or screen. For example, in the case of listening to music on a smart phone, the user necessarily turns on a screen (display) or system and then performs an input in order to control a music application. This means that power is used for turning on the screen, and the user should perform the processes described above, which are complicated.

Fourth, the conventional device necessarily requires button inputs to perform other system controls. The physical button (soft button) acts as a very serious limitation in the design of the device. For example, the physical button (soft button) hinders aesthetic elements on the design and restricts a waterproof design, etc.

Fifth, there are many cases where users (children or elderly persons) who are not good at using the touch screen are also poor at executing applications. This is because these users feel that the process of executing an application is a very complicated process.

The method for unlocking the device (electronic device), described in Korean Patent Publication No. 10-2013-0123261 is also a method for releasing locking of the device when a touch input for turning on a display is sensed in a state in which a switch image in an off state is controlled to be displayed on a screen of the display. Like the problems of the conventional method described above, a separate process of turning on the display should be performed so that unlocking or system control is possible, which is inconvenient and complicated.

### SUMMARY

Accordingly, the present invention has been made keeping in mind the above problems occurring in the prior art, and an aspect of the present invention is to provide a device driving system which enables a user to quickly perform system control of the device or execution of an application even in a low power mode in which a display of the device is off.

Another aspect of the present invention is to provide a device driving system which can quickly perform unlocking of a device, system control or execution of an application while minimizing power consumption through only a predetermined touch input in a low power mode in which a display of the device is off.

A further aspect of the present invention is to provide a device driving system which can minimize power consumption in a low power mode by executing a low power algorithm for minimizing demands of an algorithm for analysis of a user's touch input, limiting and setting an effective touch area of a touch panel to a partial area of the touch panel, minimizing the number of scans required of the effective touch area of the touch panel, or changing a touch input method between a general mode and the low power mode.

Yet another aspect of the present invention is to provide a device driving system which can allow a user to set a user's own touch input for executing a specific application in a low power mode, and increase a recognition rate with respect to a predetermined touch input by storing information on a touch input pattern input by the user and databasing the pattern type of a specific touch input through the storing of the information.

In order to accomplish the above aspect(s), the present invention provides a device driving system through a touch input in a low power mode in which a display is off, the device driving system including: a touch panel; a touch screen controller configured to sense a touch input on the touch panel and transmit/receive corresponding information; and an application processor configured to drive an application of a device, using the information transmitted from the touch screen controller, and set modes of the touch panel and the touch screen controller, wherein the application processor includes a low power mode setting module configured to convert the mode of the touch screen controller into the low power mode when there is no touch input for a certain period of time or when the device is off, and the touch screen controller includes a low power mode touch recognition unit configured to sense only a predetermined touch input in the low power mode, to sense only the predetermined touch input even in the low power mode in which the display is off, thereby quickly driving the device while minimizing power consumption.

The low power mode touch recognition unit may include an unlocking touch recognition module configured to sense a predetermined unlocking touch input in the low power mode, thereby quickly moving to a home screen of the device.

The low power mode touch recognition unit may include a system control touch recognition module configured to sense a predetermined system control touch input in the low power mode, thereby quickly controlling a device system.

The system control touch input may be a control touch input with respect to a background application operating even in the low power mode in which the display is off.

The low power mode touch recognition unit may include an application execution touch recognition module configured to sense a predetermined application execution touch input in the low power mode, thereby quickly executing an application in the device.

The low power mode touch recognition unit may include a low power algorithm obtained by minimizing an algorithm for analyzing a user's touch input in order to minimize power consumption in the low power mode.

The low power mode touch recognition unit may further include a touch area limitation setting module configured to limit and set an effective touch area of the touch panel as a partial area of the touch panel in the low power mode.

The low power mode touch recognition unit may minimize power consumption in the low power mode by minimizing the number of scans required of the effective touch area of the touch panel, set in the touch area limitation setting module.

The low power mode touch recognition unit may include a touch input change module configured to change a touch input method between in a general mode and the low power mode in order to minimize power consumption in the low power mode.

The touch input change module may allow a touch input in the general mode to be performed using a mutual-cap method, and allow a touch input in the low power mode to be performed using a self-cap method.

The low power mode touch recognition unit may include a touch input setting module configured to enable the user to set a user's own touch input for executing a specific application in the low power mode.

The low power mode touch recognition unit may further include a pattern database module configured to increase a recognition rate with respect to a predetermined touch input by storing information on a user's touch input pattern input in the low power mode and databasing the pattern type of a specific touch input through the storing of the information.

According to the present invention, it is possible to enable a user to quickly perform execution of a system control or application of the device even in the low power mode in which the display of the device is off.

Further, it is possible to quickly perform unlocking of a device, system control or execution of an application while minimizing power consumption through only a predetermined touch input in the low power mode in which the display of the device is off.

Further, it is possible to minimize the power consumption in the low power mode by executing a low power algorithm for minimizing an algorithm for analysis of a user's touch input, limiting and setting an effective touch area of the touch panel to a partial area of the touch panel, minimizing the number of scans required of the effective touch area of the touch panel, or changing a touch input method between the general mode and the low power mode.

Further, it is possible to allow a user to set a user's own touch input for executing a specific application in a low power mode, and to increase a recognition rate with respect to a predetermined touch input by storing information on a touch input pattern input by the user and databasing the pattern type of a specific touch input through the storing of the information.

### BRIEF DESCRIPTION OF THE DRAWINGS

FIG. 1 is a configuration diagram illustrating a device driving system according to an embodiment of the present invention;

FIG. 2 is a flowchart illustrating operations between components of the device driving system of the present invention;

FIGS. 3A and 3B are block diagrams illustrating a difference in performance between the conventional art and the present invention up to a home screen movement through unlocking;

FIG. 4 is a reference diagram illustrating the home screen movement through an unlocking touch input according to the present invention;

FIGS. 5A and 5B are block diagrams illustrating a difference in performance up to system control between the conventional art and the present invention;

FIG. 6 is a reference diagram illustrating control of a background touch input through a control touch input to the background application according to the present invention;

FIGS. 7A and 7B are block diagrams illustrating a difference in performance up to application execution between the conventional art and the present invention;

FIG. 8 is a reference diagram illustrating the application execution through an application execution touch input according to the present invention; and

FIG. 9 is a reference diagram illustrating setting examples of various touch inputs to be input in a low power mode according to the present invention.

### DETAILED DESCRIPTION

Reference should now be made to the drawings, in which the same reference numerals are used throughout the different drawings to designate the same or similar components. In the following description, detailed explanation of known related functions and constitutions may be omitted to avoid unnecessarily obscuring the subject manner of the present invention. In the entire specification, when a certain portion “includes” a certain component, this indicates that the other components are not excluded, but may be further included unless specially described. The terms “unit”, “module” or the like described in the specification indicates a unit for processing at least one function or operation, which may be implemented by hardware, software and a combination thereof

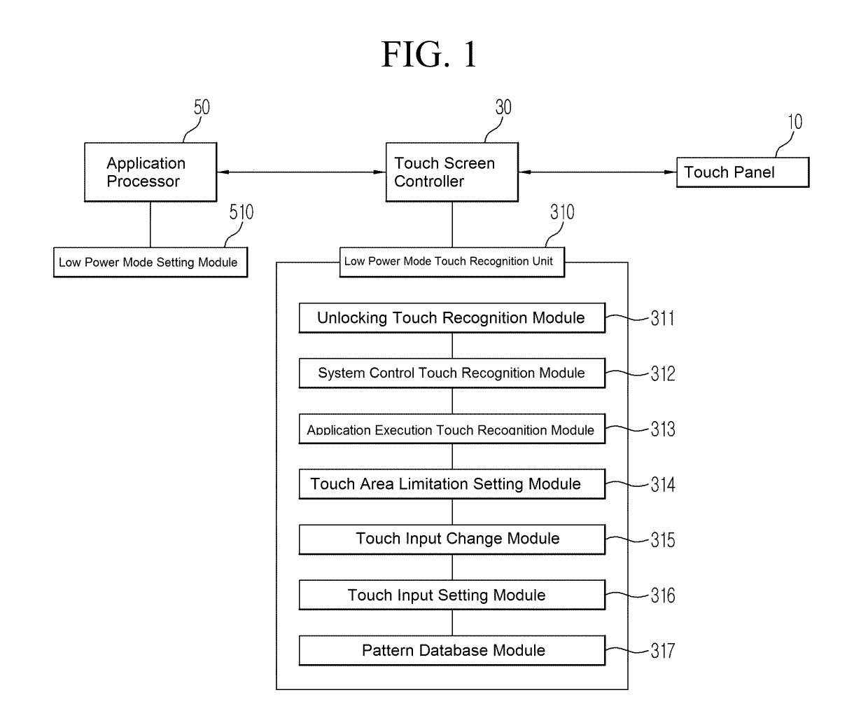

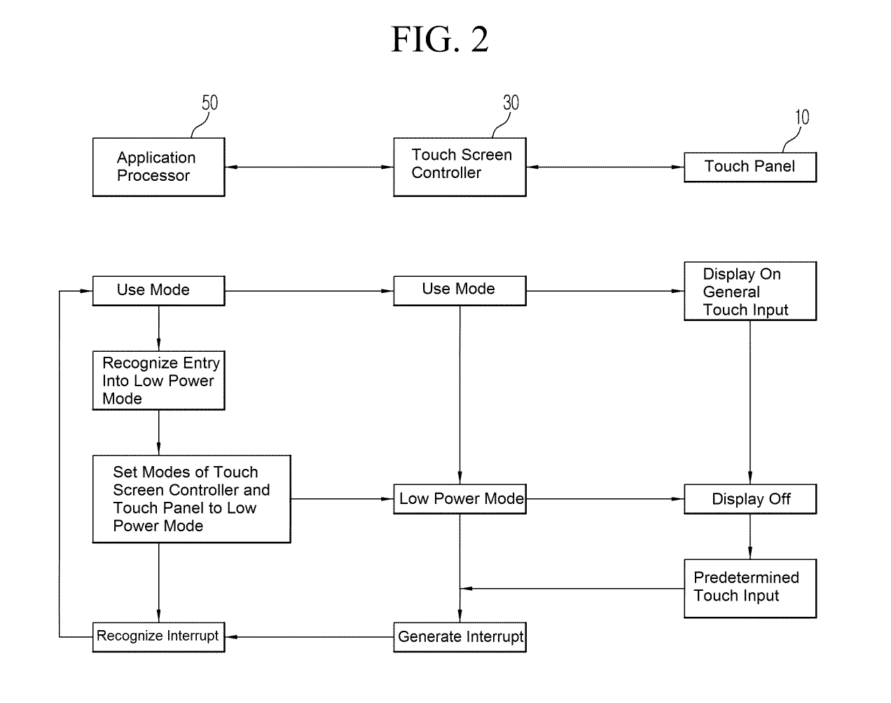

Referring to FIGS. 1 to 9, a device driving system through a touch input in a low power mode in which a display is off according to an embodiment of the present invention includes a touch panel 10, a touch screen controller 30 for sensing a touch input on the touch panel 10 and transmitting/receiving corresponding information, and an application processor 50 for driving an application of a device, using the information transmitted from the touch screen controller 30, and setting modes of the touch panel 10 and the touch screen controller 30. The application processor 50 may include a low power mode setting module 510 for converting the mode of the touch screen controller 30 into a low power mode when there is no touch input for a certain period of time or when the device is off. The touch screen controller 30 may include a low power mode touch recognition unit 310 for sensing only a predetermined touch input in the low power mode.

The touch panel 10 is a display panel of the device. Particularly, the touch panel 10 is a display panel on which a touch input is possible to enable the device to be driven by sensing a user's touch input (here, the touch input is a concept including all inputs which can be generated and distinguished in a touch device, such as touch coordinates, a touch size, a gesture, a pattern, a touch time interval, and the like) and transmitting/receiving information on the sensed touch input.

The touch screen controller 30 is a component for sensing a touch input on the touch panel 10 and transmitting/receiving corresponding information. When the user performs a touch input through the touch panel 10, the touch screen controller 30 senses the touch input and transmits corresponding information to the application processor 50 which will be described later. In addition, the touch screen controller 30 operates under a control transmitted from the application processor 50. Particularly, in the present invention, the touch screen controller 30 includes the low power mode touch recognition unit 310 capable of sensing a predetermined touch input while minimizing power consumption even in a separate low power mode. This will be described later.

The application processor 50 is a component for driving (or executing) an application of the device and/or a system control, using the information transmitted from the touch screen controller 30, and setting (controlling) the mode(s) of the touch panel 10 and/or the touch screen controller 30. That is, when the information transmitted from the touch screen controller 30 is related to driving of an application, the application processor 50 controls the corresponding application. Alternatively, when the information transmitted from the touch screen controller 30 is related to a system control of the device, the application processor 50 controls the corresponding system control. When there is no separate touch input for a certain period (predetermined period), the mode of the touch panel 10 or the touch screen controller 30 is converted into the low power mode. On the contrary, when a specific touch input is sensed in the low power mode, the mode of the touch panel 10 or the touch screen controller 30 is converted into a general mode (state in which the display is on). To this end, the application processor 50 may include the low power mode setting module 510 for converting the mode of the touch screen controller 30 into the low power mode, particularly, when there is no touch input for a certain period of time or when the device is off.

The low power mode setting module 510 is a component for converting the mode of the touch screen controller 30 into the low power mode when there is no touch input for a certain period of time or when the device is off. When the user does not use the device through the touch panel 10 for a certain period of time (i.e., the user does not any touch input) or when the user turns off the device, the low power mode setting module 510 recognizes this as an entry into the low power mode and changes the mode of the touch screen controller 30 to the low power mode. Generally, any touch input on the touch panel 10 is not recognized in a state in which the touch panel 10 is off, and a touch input is recognized only in a state in which the touch panel 10 is again on. In the present invention, the touch screen controller 30 may include the separate low power mode touch recognition unit 310 in order to sense a predetermined touch input and immediately execute a system control or application while consuming only minimum power under the low power mode.

The low power mode touch recognition unit 310 is a component for sensing only a predetermined touch input while minimizing power consumption in the low power mode. Under the low power mode, the touch screen controller 30 filters only a predetermined (promised) user touch input through the lower power mode touch recognition unit 310. If the user's touch input is sensed, the touch screen controller 30 transmits an interrupt to the application processor 50. When the user's touch input is not the predetermined touch input, the touch screen controller 30 disregards the user's touch input and maintains the low power mode. More specifically, the lower power mode touch recognition unit 310 may include an unlocking touch recognition module 311 for sensing a predetermined unlocking touch input in the lower power mode and enabling the device to quickly move to a home screen, a system control touch recognition module 312 for sensing a predetermined system control touch input in the low power mode and enabling the device to quickly control a device system, and an application execution touch recognition module 313 for sensing a predetermined application execution touch input in the low power mode and enabling the device to quickly execute an application.

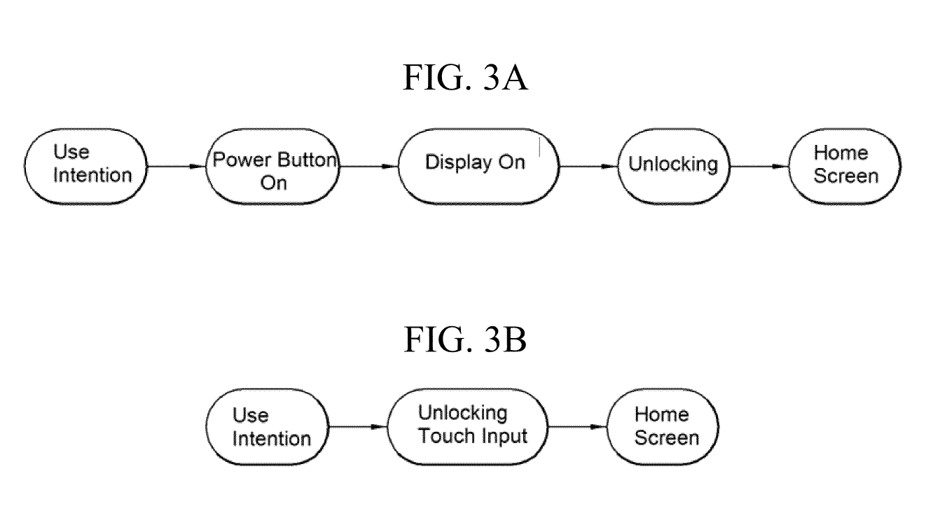

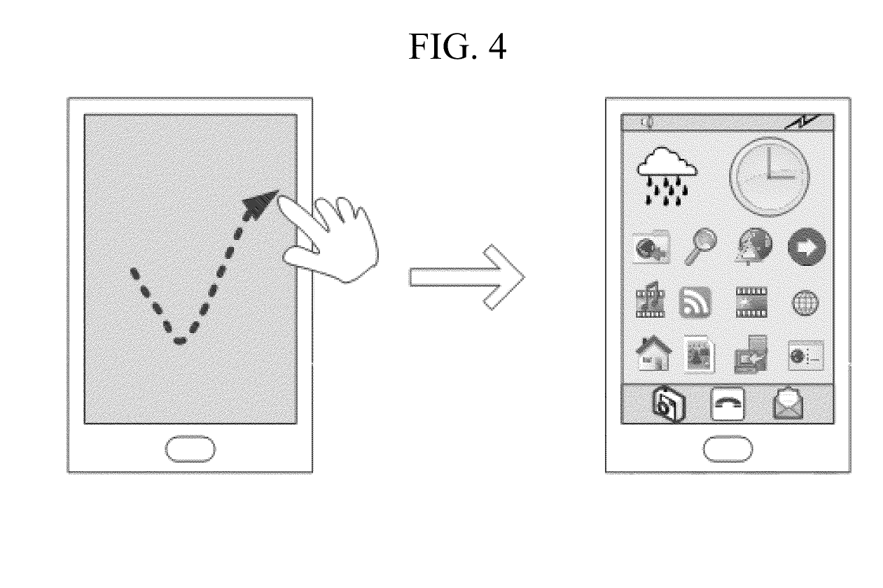

The unlocking touch recognition module 311 is a component for sensing a predetermined unlocking touch input in the lower power mode and enabling the device to quickly move to the home screen. That is, conventionally, in order for the device to release its locking and move to the home screen in the low power mode, the user, as shown in FIG. 3A, separately turned on (activated) the display (touch panel), using a power button of the device, and then performed an unlocking pattern input (or personal identification number input) on the touch panel where a screen was turned on (a locking screen appeared). Therefore, the performance time from when the user intended to move from the home screen in the low power mode to when the device actually moved to the home screen were increased. On the other hand, in the present invention, if the user, as shown in FIG. 3B, immediately performs a predetermined unlocking touch input on the touch panel in the low power mode without separately turning on (activating) the touch panel 10 even in the low power mode through the unlocking touch recognition module 311, the unlocking touch recognition module 311 senses the predetermined unlocking touch input, thereby quickly moving the device to the home screen. An example will be described with reference to FIG. 4. As shown in FIG. 4, when the user immediately performs an unlocking touch input of a predetermined ‘v’ shape on the touch panel in the low power mode (i.e., the state in which the touch panel 10 is off), the unlocking touch recognition module 311 senses the unlocking touch input and enables the device to quickly move to the home screen, so that it is possible to quickly perform the unlocking of the device while minimizing power consumption.

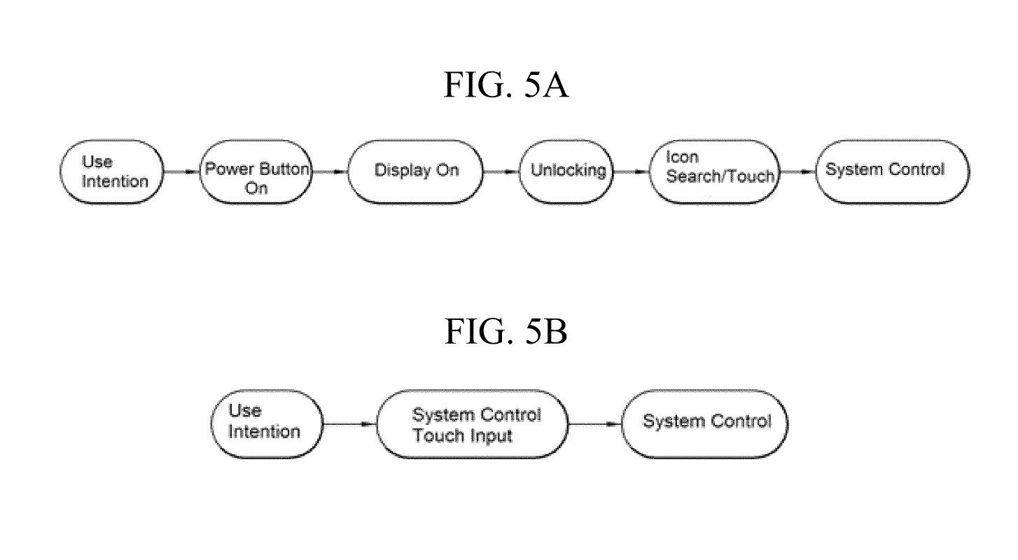

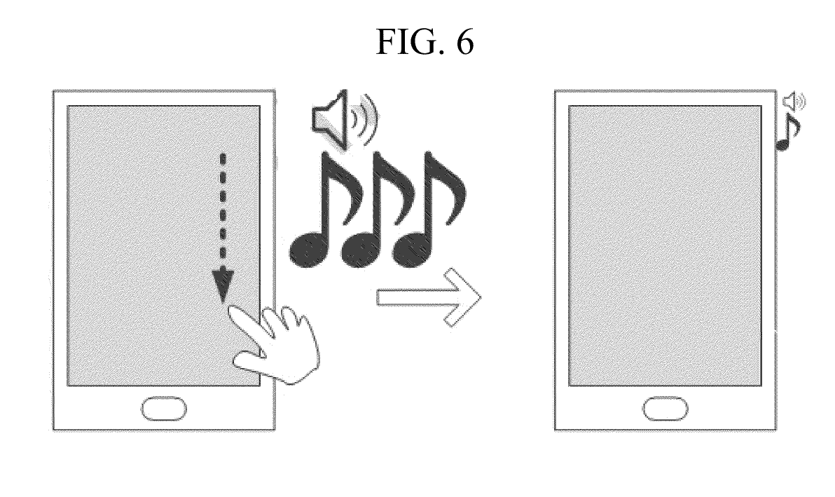

The system control touch recognition module 312 is a component for sensing a predetermined system control touch input in the low power mode and enabling the device to quickly control the device system. That is, conventionally, in order for the device to execute a system control (here, the system control includes a system menu, a volume control, a vibration-sound mode conversion, and a control of a background application operating even under the low power mode) in the low power mode, the user, as shown in FIG. 5A, turned on (activated) the display (touch panel), separately using the power button of the device, and then performed a control input on an icon or screen of the corresponding background application in a state in which the locking of the device was released by performing an unlocking pattern input (or personal identification number input) on the touch panel where a screen was turned on (a locking screen appeared). Therefore, the performance time from when the user intended to use the device and move to the home screen in the low power mode to when the device actually moved to the home screen was increased. On the other hand, in the present invention, if the user, as shown in FIG. 5B, immediately performs a predetermined system control touch input on the touch panel in the low power mode without separately turning on (activating) the touch panel 10 even in the low power mode through the system control touch recognition module 312, the system control touch recognition module 312 senses a predetermined system control touch input, thereby quickly executing a control of the background application, and the like. An example will be described with reference to FIG. 6. As shown in FIG. 6, when the user immediately performs a predetermined touch input (e.g., a touch input of a ‘downward straight line’ shape) on the touch panel 10 (or a specific area particularly partitioned) in order to adjust the volume of a music application (background application) being executed in the low power mode (i.e., the state in which the touch panel 10 is off), the system control touch recognition module 312 senses the predetermined touch input and enables the volume of the music application to be quickly lowered, so that it is possible to quickly execute the system control of the device while minimizing power consumption.

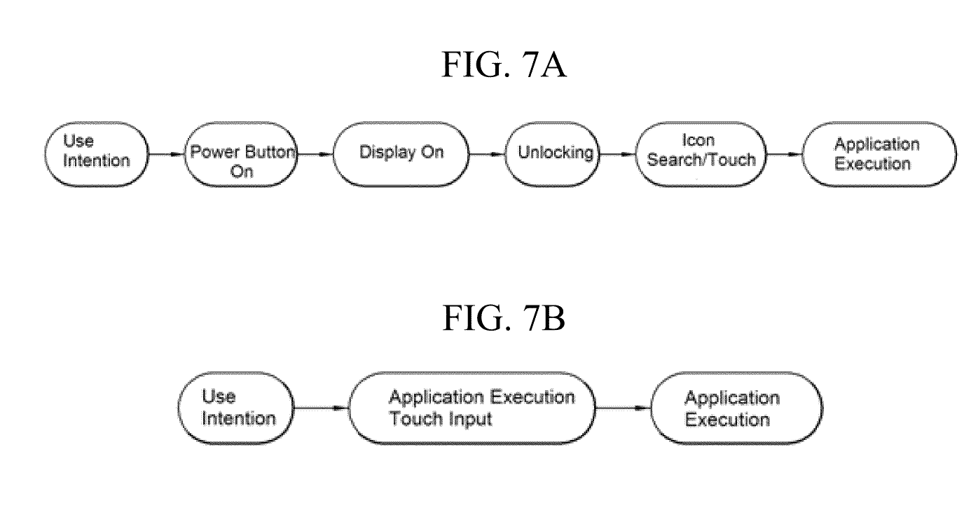

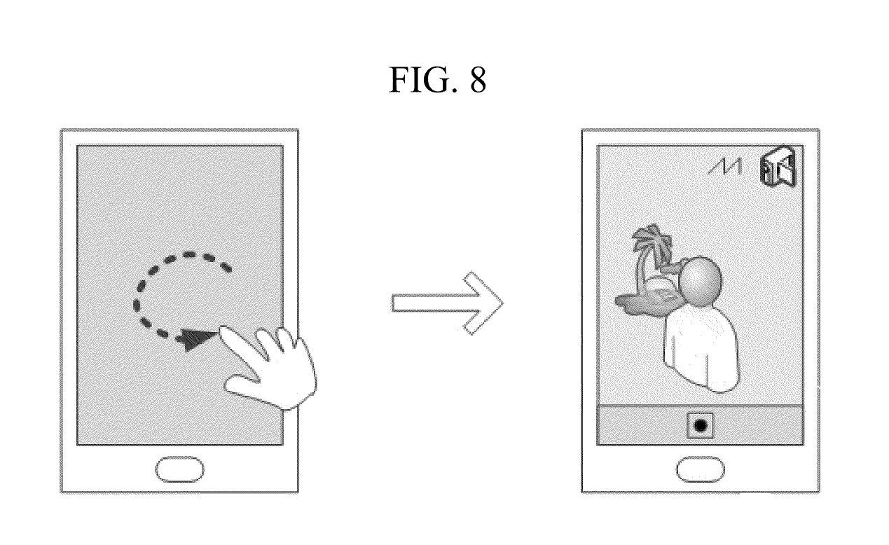

The application execution touch recognition module 313 is a component for sensing a predetermined application execution touch input in the low power mode and enabling the device to quickly execute an application. That is, conventionally, in order for the device to execute a specific application in the low power mode, the user, as shown in FIG. 7A, turned on (activated) the display (touch panel), separately using the power button, and then executed the corresponding application by touching an icon of the application on the touch panel where a screen was turned on (a locking screen appeared). Therefore, the performance phase and time from when the user had an intention to allow the device to move to the home screen in the low power mode to when the device actually moved to the home screen were increased. On the other hand, in the present invention, if the user, as shown in FIG. 7B, immediately performs a predetermined application execution touch input on the touch panel in the lower power mode without separately turning on (activating) the touch panel 10 even in the low power mode through the application execution touch recognition module 313, the application execution touch recognition module 313 senses the predetermined application execution touch input, thereby quickly executing the corresponding application. An example will be described with reference to FIG. 8. As shown in FIG. 8, when the user immediately performs a predetermined touch input (e.g., a touch input of a ‘c’ shape) on the touch panel 10 (e.g., a specific area particularly partitioned) in order to execute a photo application in the low power mode (i.e., the state in which the touch panel 10 is off), the application execution touch recognition module 313 senses the predetermined touch input and executes the corresponding photo application previously set in the corresponding touch input, so that it is possible to quickly execute the application of the device while minimizing power consumption.

Meanwhile, in the present invention, the device driving system may include components capable of increasing a recognition rate while minimizing power consumption. Specifically, the low power mode touch recognition unit 310 may include a low power algorithm obtained by minimizing an algorithm for analyzing a user's touch input in order to increase the recognition rate in the state in which the power consumption is minimized. That is, in order to increase the recognition rate with respect to a predetermined touch input under the low power mode, the low power mode touch recognition unit 310 of the touch screen controller 30 includes a low power algorithm for sensing only a predetermined touch input under the low power mode, so that it is possible to increase the recognition rate with respect to the touch input in the state in which the power consumption is minimized.

The low power mode recognition unit 310 may further include a touch area limitation setting module 314 for limiting and setting an effective touch area to a partial area of the touch panel in the low power mode. That is, the touch area limitation setting module 314 limits only a partial area on the touch panel 10 to an effective touch area where a touch input is possible in the state in which the touch panel 10 is off, so that it is possible to minimize power consumption for sensing a touch input in the low power mode and to increase the recognition rate with respect to the touch input.

The low power mode touch recognition unit 310 minimizes the number of scans required of the effective touch area of the touch panel set in the touch area limitation setting module 314, thereby minimizing the power consumption in the low power mode. That is, the low power mode touch recognition unit 310 limits an effective touch area where a touch input is possible in the low power mode on the touch panel 10 and simultaneously minimizes the number of scans required of the corresponding effective touch area to a predetermined level or less, thereby achieving minimum power consumption.

The low power mode recognition unit 10 may include a touch input change module 315 for changing the touch input methods in the general mode and the low power mode in order to increase the recognition rate while minimizing power consumption in the low power mode.

Particularly, the touch input change module 315 allows a touch input in the general mode to be performed using a mutual-cap method variously applied while enabling relatively various touch inputs, and then allows a touch input in the low power mode to be performed using a self-cap method capable of minimizing power consumption while enabling use of only a simple touch input. Thus, it is possible to minimize power consumption while enabling touch input under the low power mode.

Meanwhile, in the present invention, the device driving system may further include a touch input setting module 316 for enabling the low power mode touch recognition unit 310 to set its own touch input so that the user executes a specific application or performs a specific operation in the low power mode.

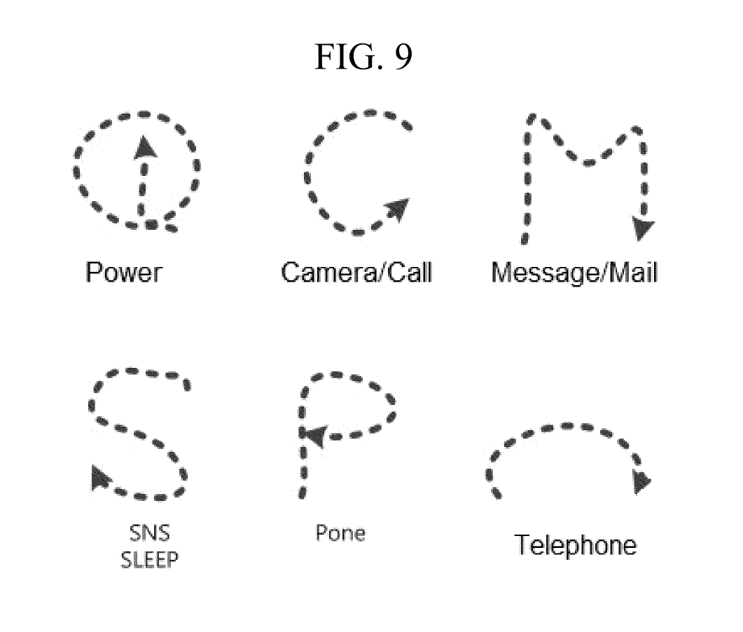

The touch input setting module 316 is a component for enabling the user to set and use a touch input for executing a specific application or performing a specific operation as a user's own pattern, gesture or the like. That is, the user, as shown in FIG. 9, sets and uses various touch inputs which can be performed in the low power mode as the user's unique touch inputs (unique patterns, gestures or the like), so that it is possible to more familiarly, naturally and quickly perform driving of the device in the low power mode.

The low power mode recognition unit 310 may further include a pattern database module 317 for storing information on a user's touch input pattern input in the low power mode and databasing the pattern type of a specific touch input through the storing of the information, thereby increasing the recognition rate with respect to a predetermined touch input.

The pattern database module 317 is a component for storing information on a user's touch input pattern input in the low power mode and databasing the pattern type of a specific touch input through the storing of information, thereby increasing the recognition rate with respect to a predetermined touch input. As described above, in the sensing of a user's touch input performed under the low power mode, the low power algorithm or the number of scans required is limited to minimize the power consumption, and only a predetermined touch input (or a form equal thereto) is sensed. Hence, in order to increase the recognition rate with respect to the predetermined touch input, pattern types input with respect to the corresponding touch input by the user are stored, databased and managed through the pattern database module 317, thereby increasing the recognition rate with respect to the corresponding touch input performed by the user.

While the present invention has been described with reference to the embodiments and accompanying drawings, it should be interpreted that terms or words used in the description and claims should not be interpreted as being limited merely to common and dictionary meanings but should be interpreted as having meanings and concepts which are defined within the technical scope of the present invention. Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A device driving system through a touch input in a low power mode in which a display is off, the device driving system comprising:
a touch panel;
a touch screen controller configured to sense a touch input on the touch panel and transmit/receive corresponding information; and
an application processor configured to drive an application of a device, using the information transmitted from the touch screen controller, and set modes of the touch panel and the touch screen controller,
wherein the application processor includes a low power mode setting module configured to convert the mode of the touch screen controller into the low power mode when there is no touch input for a certain period of time or when the device is off, and the touch screen controller includes a low power mode touch recognition unit configured to sense only a predetermined touch input in the low power mode, to sense only the predetermined touch input even in the low power mode in which the display is off, thereby quickly driving the device while minimizing power consumption.

2. The device driving system of claim 1, wherein the low power mode touch recognition unit includes an unlocking touch recognition module configured to sense a predetermined unlocking touch input in the low power mode, thereby quickly moving to a home screen of the device.

3. The device driving system of claim 1, wherein the low power mode touch recognition unit includes a system control touch recognition module configured to sense a predetermined system control touch input in the low power mode, thereby quickly controlling a device system.

4. The device driving system of claim 3, wherein the system control touch input is a control touch input with respect to a background application operating even in the low power mode in which the display is off.

5. The device driving system of claim 1, wherein the low power mode touch recognition unit includes an application execution touch recognition module configured to sense a predetermined application execution touch input in the low power mode, thereby quickly executing an application in the device.

6. The device driving system of claim 1, wherein the low power mode touch recognition unit includes a low power algorithm obtained by minimizing an algorithm for analyzing a user's touch input in order to minimize the power consumption in the low power mode.

7. The device driving system of claim 6, wherein the low power mode touch recognition unit further includes a touch area limitation setting module configured to limit and set an effective touch area of the touch panel as a partial area of the touch panel in the low power mode.

8. The device driving system of claim 7, wherein the low power mode touch recognition unit minimizes the power consumption in the low power mode by minimizing the number of scans required of the effective touch area of the touch panel, set in the touch area limitation setting module.

9. The device driving system of claim 1, wherein the low power mode touch recognition unit includes a touch input change module configured to change a touch input method between a general mode and the low power mode in order to minimize the power consumption in the low power mode.

10. The device driving system of claim 9, wherein the touch input change module allows a touch input in the general mode to be performed using a mutual-cap method, and allows a touch input in the low power mode to be performed using a self-cap method.

11. The device driving system of claim 1, wherein the low power mode touch recognition unit includes a touch input setting module configured to enable the user to set a user's own touch input for executing a specific application in the low power mode.

12. The device driving system of claim 11, wherein the low power mode touch recognition unit further includes a pattern database module configured to increase a recognition rate with respect to a predetermined touch input by storing information on a user's touch input pattern input in the low power mode and databasing the pattern type of a specific touch input through the storing of the information.
